(19) United States
(12) Patent Application Publication
(10) Pub. No.: US 2021/0220194 A1
(43) Pub. Date: Jul. 22, 2021

(54) Mobility tool for the elderly to go out

(71) Applicant: Xiaomei HUANG, Nantong (CN)

(72) Inventors: Xiaomei HUANG, Nantong (CN); Yuanhong MAO, Nantong (CN)

(21) Appl. No.: 16/772,172

(22) PCT Filed: Dec. 26, 2018
(86) PCT No.: PCT/CN2018/123850

§ 371 Date: Jun. 12, 2020

(30) Foreign Application Priority Data
Dec. 21, 2018 (CN) 201811571526.X

(51) Int. Cl. A61G 5/04; A61G 5/12

(52) U.S. Cl. CPC A61G 5/04; A61G 5/14; A61G 5/125

(57) ABSTRACT

The invention discloses a mobility tool which is convenient for the elderly to go out, which includes an electric wheel chair support leg, and a plurality of electric wheelchair support legs are all fixedly connected with a bottom plate on the surface. The mobility tool for the elderly to go out, when in use, when the elderly need to take a wheelchair, stand next to the wheelchair and hold the sheath on the armrest, lean back on the surface of the seat floor, open the motor to rotate and drive The rotating shaft rotates to drive the turbine to rotate, and the worm rotates through the engagement, which drives the pinion to rotate and the large gear to rotate, and the connecting rod moves downward to make the elderly slowly sit down.

### TECHNOSPHERE

The present invention relates to the technical field of wheelchairs, and more specifically, it relates to a mobility tool for the elderly to go out.

### BACKGROUND TECHNOLOGY

The wheelchair is an important tool for rehabilitation. The wheelchair is not only a mobility tool for the physically handicapped and people with reduced mobility, but more importantly, it is to enable them to use the wheelchair for physical exercise and participate in social activities.

Nowadays, most wheelchair seats are fixed and cannot be adjusted. When the elderly are inconvenient to move, when they are going to sit on the seats, because the seats cannot be adjusted, the elderly will be inconvenient to sit down. Sitting on the lower back slowly, being unable to use the seat by yourself increases labor costs. When the elderly use it by themselves, it is inconvenient to produce injury threats, so a mobility tool is needed for the elderly to go out.

### CONTENTS OF THE INVENTION

In view of the shortcomings of the prior art, the object of the present invention is to provide a mobility tool, for the elderly to go out, which has the characteristics of saving labor costs, avoiding physical injuries of the elderly, and facilitating the adjustment of the elderly in wheelchairs.

To achieve the above objectives, the present invention provides the following technical solutions:

A mobility tool for the elderly to go out includes an electric wheelchair support leg. The surfaces of the multiple electric wheelchair support legs are fixedly connected to a bottom plate. The surface of the bottom plate is provided with a first adjustment device, and the first adjustment device includes a motor bottom plate. A stand plate is fixedly connected to the upper surface of the bottom plate, and the surface of the stand plate is fixedly connected to the surface of the support leg of the electric wheelchair. The surface of the stand plate is provided with a second adjustment device, and the second adjustment device includes a first bearing, The outer ring is fixedly connected to the surface of the stand board, the seat bottom frame is fixedly connected to the tops of the support legs of multiple electric wheelchairs, and the seat bottom frame is hinged to the inner wall of the seat bottom frame.

Further, a reinforcing plate is fixedly connected to the surface of the motor bottom plate, and the surface of the reinforcing plate is fixedly connected to the lower surface of the bottom plate.

Further, the inner ring of the first bearing is fixedly connected with the gear shaft, the surface of the gear shaft is fixedly connected with the large gear, the side surface of the large gear is fixedly connected with the fixed shaft, the surface of the fixed shaft is hinged with the connecting rod, and the two connecting rods are hinged Both ends are hinged to the bottom of the seat bottom.

Further, a bearing seat is fixedly connected to the upper surface of the bottom plate, a second bearing is fixedly connected to the surface of the bearing seat, a pinion shaft is fixedly connected to the inner ring of the second bearing, and a pinion gear and a pinion gear are fixedly connected to one end of the pinion shaft The surface of the gear meshes with the surface of the large gear, and the worm is fixedly connected to the other ends of the two small gear shafts.

Further, a motor is fixedly connected to the surface of the motor bottom plate, a rotary shaft is fixedly connected to the output shaft of the motor, a turbine is fixedly connected to one end of the rotary shaft, the surface of the rotary shaft is in constant communication with the surface of the bottom plate, and the surface of the turbine is The surface of the worm is engaged.

Further, the other side surface of the large gear is fixedly connected with a contact, the upper surface of the bottom plate is fixedly connected with a limit block, the top of the limit block is fixedly connected with a lower limit switch, and the surface of the contact is in contact with the contact point of the lower limit switch, The upper surface of the station board is fixedly connected with an upper limit switch.

Further, the model of the upper limit switch and the lower limit switch is YBLXW-5-11G2, and the model of the motor is 60HS10014A4.

Further, an armrest is fixedly connected to the upper surface of the seat bottom frame, and a sheath is fixedly connected to the surface of the armrest.

Further, the material of the sheath includes a water-absorbent resin, and the processing method of the water absorbent resin material: S1, measure 10 mL of acrylic acid in a 100 mL beaker with 20 mL of water, and slowly drop a 30% NaOH aqueous solution to pH=6-7. After the neutralization solution is cooled to room temperature, add 5.5 g of amine acrylate to the neutralization solution, and then transfer to a 250 mL beaker equipped with a stirrer. S2, weigh 4.4 g of soluble starch and add 20 mL of distilled water. Heat to 80° C.-100° C. to make it gelatinize. After gelatinizing, quickly transfer it to the above 250 mL beaker, then add 0.4 g Triton X-100.

Further, S3, dissolve 0.132 g of ammonium persulfate in 10 mL of water, slowly drop it into the reaction solution with a thermostatic pressure dropping funnel, react at a constant temperature water bath at 60° C. for 2 hours, and slowly add 0.0128 dissolved in 10 mL of water gCrosslinking agent N, N′-methylenebisacrylic acid amine, continue stirring for half an hour, S4, the gum obtained by the reaction is washed several times with water, washed once with ethanol, suction filtered, and then put in 105 Dry at ° C. for 25 h, grind and pulverize to obtain powdery water-absorbent resin.

In summary, the present invention has the following beneficial effects:

1. By installing a plurality of electric wheelchair supporting legs, the bottom plate is fixedly connected to the surface, the surface of the bottom plate is provided with a first adjustment device, and the first adjustment device includes a motor bottom plate, and the surface of the standing plate is provided with a second adjustment device, and The second adjustment device includes a first bearing, which has the characteristics, of saving labor costs, avoiding physical injuries of the elderly, and facilitating the adjustment of the elderly in a wheelchair. When in use, when the elderly need to take a wheelchair, stand next to the wheelchair With the sheath on the armrest, leaning back on the surface of the seat bottom, turn on the motor and drive the rotation shaft to rotate the turbine, and the worm rotates, through the meshing, which drives the pinion to rotate and the large gear to rotate. The downward movement causes the elderly to sit down slowly. When the seat bottom plate contacts the upper limit switch, it stops. When it is not needed, the motor is rotated to drive the contact to contact the lower limit switch to stop the seat bottom plate at an oblique angle. In order to prepare the elderly to take a wheelchair, it can save labor costs, avoid the physical injuries of the elderly, and facilitate the adjustment of the elderly in wheelchairs.

2. The material of the sheath includes water-absorbent resin, so as to achieve the effect of sweating absorption of the elderly in the wheelchair armrest for a long time, and keep the hand dry for a long time. Environmental protection effect.

### FIGURE ILLUSTRATION

FIG. 1 is a schematic diagram of the structure of the present invention;

FIG. 2 is a perspective view of the seat base structure of the present invention;

FIG. 3 is a front view of the bottom plate structure of the present invention;

FIG. 4 is a side view of the motor structure of the present invention;

FIG. 5 is a side view of the structure of the large gear of the present invention;

FIG. 6 is an enlarged view of the structure at position A in FIG. 3 of the present invention.

In the picture: 1. Electric wheelchair support legs; 2. Base plate; 3. Motor base plate; 31. Motor; 32. Rotating shaft; 33. Turbine; 4. Stand plate; 5. First bearing; 51. Gear shaft; 52. Large gear; 53, fixed shaft; 54, connecting rod; 6, seat bottom frame; 7, seat bottom plate; 8, reinforcement plate; 9, bearing seat; 10, second bearing; 11, pinion shaft; 12, Pinion; 13. Worm; 14. Contact; 15. Limit block; 16. Lower limit switch; 17. Upper limit switch; 18. Armrest; 19. Sheath.

### SPECIFIC IMPLEMENTATION MODALITIES

### Example

The present invention will be further described in detail below in conjunction with the accompanying drawings 1-6.

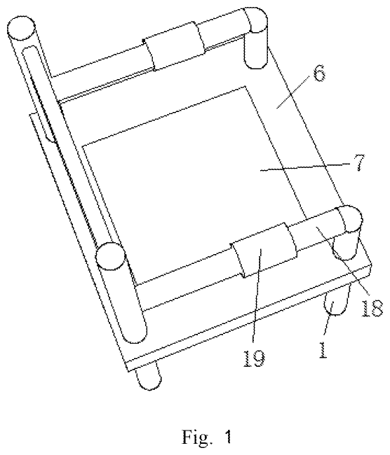

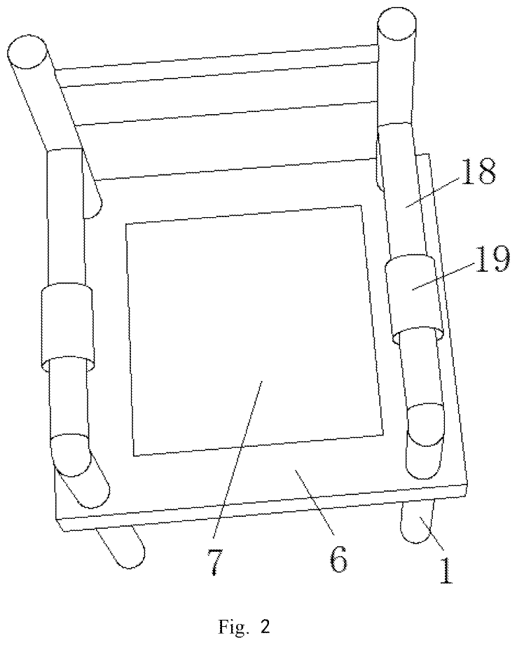

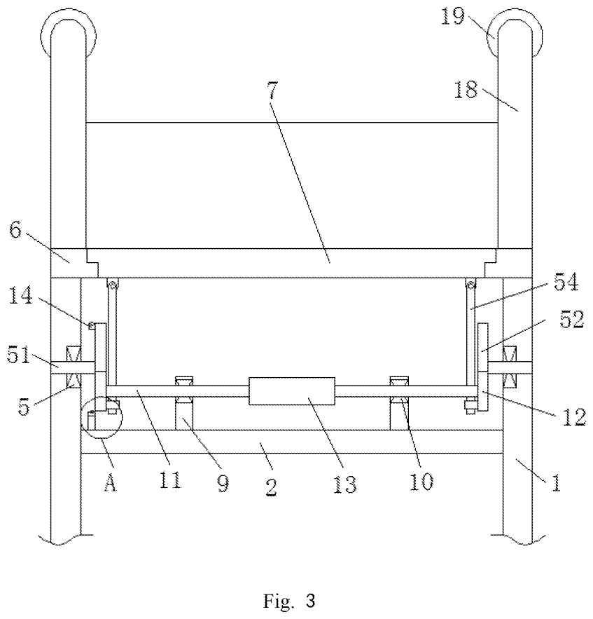

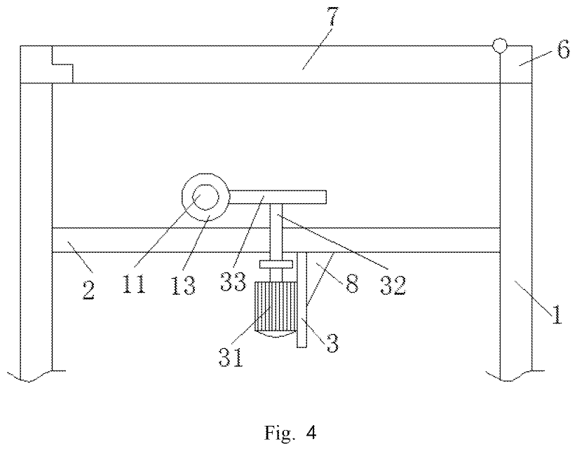

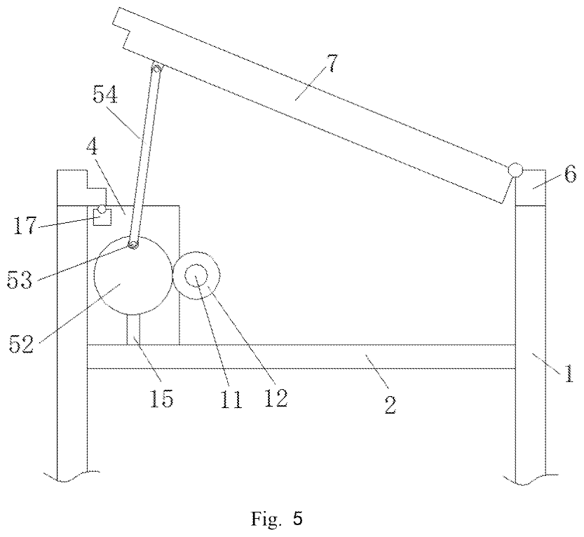

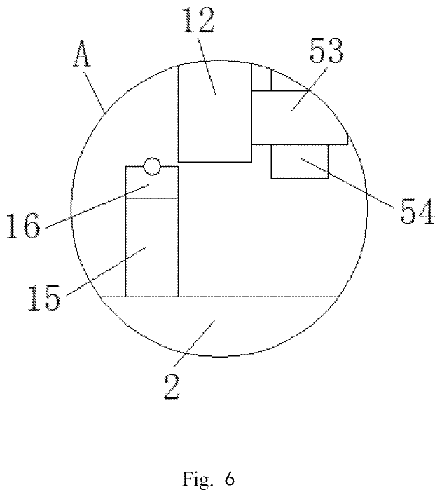

A mobility tool for the elderly to go out, as shown in FIG. 1-6, includes an electric wheelchair support leg 1, a plurality of electric wheelchair support legs 1 are fixedly connected to the bottom plate 2 on the surface, and a bearing is fixedly connected to the upper surface of the bottom plate 2 Seat 9, the surface of the bearing housing 9 is fixedly connected with the second bearing 10, the inner ring of the second bearing 10 is fixedly connected with the pinion shaft 11, one end of the pinion shaft 11 is fixedly connected with the pinion 12, the surface of the pinion 12 and The surface of the large gear 52 is meshed, the other ends of the two small gear shafts 11 are fixedly connected to the worm 13, the surface of the motor base plate 3 is fixedly connected to the motor 31, and the output shaft of the motor 31 is fixedly connected to the rotating shaft 32 through the coupling. A turbine 33 is fixedly connected to one end of the rotating shaft 32, the surface of the rotating shaft 32 is in fixed communication with the surface of the bottom plate 2, the surface of the turbine 33 meshes with the surface of the worm 13, and the contact 14 is fixedly connected to the other surface of the large gear 52, The upper surface of the bottom plate 2 is fixedly connected with the limit block 15, the top of the limit block 15 is fixedly connected with the lower limit switch 16, the surface of the contact 14 is in contact with the contact point of the lower limit switch 16, and the upper surface of the station board 4 is fixedly connected with The model of the upper limit switch 17, the upper limit switch 17 and the lower limit switch 16 may be YBLXVV-5-11G2, the model of the motor 31 may be 60HS10014A4, the surface of the bottom plate 2 is provided with a first adjustment device, and the first adjustment device includes The motor bottom plate 3, the surface of the motor bottom plate 3 is fixedly connected with a reinforcing plate 8, the surface of the reinforcing plate 8 is fixedly connected with the lower surface of the bottom plate 2, the upper surface of the bottom plate 2 is fixedly connected with a standing plate 4, the surface of the standing plate 4 and the electric wheelchair The surface of the support leg 1 is fixedly connected, the surface of the station board 4 is provided with a second adjustment device, and the second adjustment device includes a first bearing 5, the outer ring of the first bearing 5 is fixedly connected to the surface of the station board 4, a plurality of The top of the electric wheelchair support legs 1 are fixedly connected to the seat bottom frame 6, the upper surface of the seat bottom frame 6 is fixedly connected to the armrest 18, the surface of the armrest 18 is fixedly connected to the sheath 19, and the material of the sheath 19 includes water absorption Resin, and water-absorbent resin material processing method: S1, measure 10 mL of acrylic acid in a 100 mL beaker with 20 mL of water, and slowly drop 30% NaOH aqueous solution to pH=6-7, after the neutralizing solution is cooled to room temperature, Add 5.5 g of acrylic amine to the neutralization solution, then transfer to a 250 mL beaker equipped with a stirrer, S2, weigh 4.4 g of soluble starch, add 20 mL of distilled water, and heat to 80° C.-100° C. to make it paste After gelatinization, quickly transfer it to the above 250 mL beaker, then add 0.4 g Triton X-100, 33, dissolve 0.132 g ammonium persulfate in 10 mL water, and slowly drop it into the reaction with a thermostatic pressure dropping funnel In the liquid, react at a constant temperature water bath at 60° C. for 2 hours, slowly add 0.0128 g of the cross-linking agent N, N′-methylenebisacrylic acid amine dissolved in 10 mL of water, continue to stir for half an hour, S4, the reaction is colloidal After washing several times with water and once with ethanol, Suction filter, and then put into dry at 105° C. for 25 h, grinding and crushing to obtain powdery water-absorbent resin. The material of the sheath 19 includes water-absorbent resin, so as to achieve the elderly sweating in wheelchairs for a long time The effect of adsorption can keep the hands dry for a long time. Due to the recyclable characteristics of the water-absorbing resin, it has an environmental protection effect. The inner wall of the seat bottom frame 6 is hinged with the seat bottom plate 7 and the inner ring of the first bearing 5 is fixedly connected There is a gear shaft 51, a large gear 52 is fixedly connected to the surface of the gear shaft 51, a fixed shaft 53 is fixedly connected to one surface of the large gear 52, a link 54 is hinged to the surface of the fixed shaft 53, and both ends of the two links 54 are both The bottom of the seat bottom plate 7 is hinged, and the bottom plate 2 is fixedly connected to the surface of the support legs 1 of the electric wheelchair. The surface of the bottom plate 2 is provided with a first adjustment device, and the first adjustment device includes a motor bottom plate 3, a station The surface of the plate 4 is provided with a second adjustment device, and the second adjustment device includes a first bearing 5, which has the characteristics of saving labor costs, avoiding physical injuries of the elderly, and facilitating the adjustment of the elderly in a wheelchair. When used, the elderly When a wheelchair is needed, stand next to the wheelchair and hold the sheath 19 on the armrest 18, leaning back on the surface of the seat bottom 7 and turn on the motor 31 to rotate the rotating shaft 32 to rotate the turbine 33. Engagement drives the worm 13 to rotate, which drives the pinion 12 to rotate, and the large gear 52 to rotate, and drives the connecting rod 54 to move downward so that the, elderly can slowly sit down and stop when the seat bottom plate 7 contacts the upper limit switch 17, When not in use, control the motor 31 to rotate and drive the contact 14 to contact the lower limit switch 16 to stop the seat bottom plate 7 at an oblique angle to prepare the elderly to take a wheelchair, thereby saving labor costs, avoiding injuries to the elderly, and facilitating adjustment The characteristics of the elderly in wheelchairs.

### Example One

A mobility tool, for the elderly to go out, as shown in FIG. 1-6, includes an electric wheelchair support leg 1, a plurality of electric wheelchair support legs 1 are fixedly connected to the bottom plate 2 on the surface, and the upper surface of the bottom plate 2 is fixedly connected with bearings Seat 9, the surface of the bearing housing 9 is fixedly connected with the second bearing 10, the inner ring of the second bearing 10 is fixedly connected with the pinion shaft 11, and one end of the pinion shaft 11 is fixedly connected with the pinion 12 The surface of the large gear 52 is meshed, the other ends of the two small gear shafts 11 are fixedly connected to the worm 13, the surface of the motor base plate 3 is fixedly connected to the motor 31, and the output shaft of the motor 31 is fixedly connected to the rotating shaft 32 through the coupling. A turbine 33 is fixedly connected to one end of the rotating shaft 32, the surface of the rotating shaft 32 is in fixed communication with the surface of the bottom plate 2, the surface of the turbine 33 meshes with the surface of the worm 13, and the contact 14 is fixedly connected to the other surface of the large gear 52, The upper surface of the bottom plate 2 is fixedly connected with the limit block 15, the top of the limit block 15 is fixedly connected with the lower limit switch 16, the surface of the contact 14 is in contact with the contact point of the lower limit switch 16, and the upper surface of the station board 4 is fixedly connected with The model of the upper limit switch 17, the upper limit switch 17 and the lower limit switch 16 may be YBLXW-5-11G2, the model of the motor 31 may be 60HS10014A4, the surface of the bottom plate 2 is provided with a first adjustment device, and the first adjustment device includes The motor bottom plate 3, the surface of the motor bottom plate 3 is fixedly connected with a reinforcing plate 8, the surface of the reinforcing plate 8 is fixedly connected with the lower surface of the bottom plate 2, the upper surface of the bottom plate 2 is fixedly connected with a standing plate 4, the surface of the standing plate 4 and the electric wheelchair The surface of the support leg 1 is fixedly connected, the surface of the station board 4 is provided with a second adjustment device, and the second adjustment device includes a first bearing 5, the outer ring of the first bearing 5 is fixedly connected to the surface of the station board 4, a plurality of The top of the electric wheelchair support legs 1 are fixedly connected to the seat bottom frame 6, the upper surface of the seat bottom frame 6 is fixedly connected to the armrest 18, the surface of the armrest 18 is fixedly connected to the sheath 19, and the material of the sheath 19 includes water absorption Resin, and water-absorbent resin material processing method: S1, measure 10 mL of acrylic acid in a 100 mL beaker with 20 mL of water, and slowly drop 30% NaOH aqueous solution to pH=6-7, after the neutralizing solution is cooled to room temperature, Add 5.5 g of acrylic amine to the neutralization solution, then transfer to a 250 mL beaker equipped with a stirrer, S2, weigh 4.4 g of soluble starch, add 20 mL of distilled water, and heat to 80° C.—to make it gelatinize, After gelatinization, quickly transfer it to the above 250 mL beaker, then add 0.4 g Triton X-100, S3, dissolve 0.132 g ammonium persulfate in 10 mL water, and slowly drop it into the reaction solution with a thermostatic pressure dropping funnel, React at a constant temperature water bath at 60° C. for 2 hours, slowly add 0.0128 g of crosslinking agent N, N′-methylenebisacrylic acid amine dissolved in 10 mL of water, and continue stirring for half an hour. Wash several times with water, and once with ethanol, filter with suction, Then put it at 105° C. for 25 hours, grind and pulverize to obtain a powdery water-absorbent resin. The material of the sheath 19 includes water-absorbent resin, so as to achieve the effect of sweating adsorption of the elderly in the wheelchair armrest for a long time. The effect of keeping the hands dry for a long time, due to the recyclable characteristics of the water-absorbing resin, has an environmental effect. The inner wall of the seat bottom frame 6 is hinged with the seat bottom plate 7, and the inner ring of the first bearing 5 is fixedly connected to the gear shaft 51, A large gear 52 is fixedly connected to the surface of the gear shaft 51, a fixed shaft 53 is fixedly connected to one surface of the large gear 52, a link 54 is hinged to the surface of the fixed shaft 53, and both ends of the two links 54 are connected to the seat bottom The bottom of 7 is hinged, and the bottom plate 2 is fixedly connected to the surface of the supporting legs 1 of the electric wheelchair. The surface of the bottom plate 2 is provided with a first adjustment device, and the first adjustment device includes the surface of the motor bottom plate 3 and the standing plate 4 A second adjustment device is provided, and the second adjustment device includes a first bearing 5, which has the characteristics of saving labor costs, avoiding physical injuries of the elderly, and facilitating adjustment of the elderly in a wheelchair. When used, when the elderly need to take a wheelchair At the time, standing next to the wheelchair, holding the sheath 19 on the armrest 18, leaning back on the surface of the seat floor 7, turning on the motor 31 and rotating the rotating shaft 32 to rotate the turbine 33, and driving the worm 13 through engagement Rotate, which drives the pinion 12 to rotate, rotates the large gear 52, and drives the connecting rod 54 to move downward so that the elderly can slowly sit down. When the seat bottom plate 7 contacts the upper limit switch 17, it stops. When the control motor 31 rotates to drive the contact 14 to contact the lower limit switch 16 to stop the seat bottom plate 7 at an oblique angle to prepare the elderly to take a wheelchair, thereby saving labor costs, avoiding physical injuries to the elderly, and facilitating adjustment of the elderly to take a wheelchair specialty.

### Example 2

A mobility tool for the elderly to go out, as shown in FIG. 1-6, includes an electric wheelchair support leg 1, a plurality of electric wheelchair support legs 1 are fixedly connected to the bottom plate 2 on the surface, and a bearing is fixedly connected to the upper surface of the bottom plate 2 Seat 9, the surface of the bearing housing 9 is fixedly connected with the second bearing 10, the inner ring of the second bearing 10 is fixedly connected with the pinion shaft 11, one end of the pinion shaft 11 is fixedly connected with the pinion 12, the surface of the pinion 12 and The surface of the large gear 52 is meshed, the other ends of the two small gear shafts 11 are fixedly connected to the worm 13, the surface of the motor base plate 3 is fixedly connected to the motor 31, and the output shaft of the motor 31 is fixedly connected to the rotating shaft 32 through the coupling. A turbine 33 is fixedly connected to one end of the rotating shaft 32, the surface of the rotating shaft 32 is in fixed communication with the surface of the bottom plate 2, the surface of the turbine 33 meshes with the surface of the worm 13, and the contact 14 is fixedly connected to the other surface of the large gear 52, The upper surface of the bottom plate 2 is fixedly connected with the limit block 15, the top of the limit block 15 is fixedly connected with the lower limit switch 16, the surface of the contact 14 is in contact with the contact point of the lower limit switch 16, and, the upper surface of the station board 4 is fixedly connected with The model of the upper limit switch 17, the upper limit switch 17 and the lower limit switch 16 may be Y8LXW-5-11G2, the, model of the motor 31 may be 60HS10014A4, the surface of the bottom plate 2 is provided with a first adjustment device, and the first adjustment device includes The motor bottom plate 3, the surface of the motor bottom plate 3 is fixedly connected with a reinforcing plate 8, the surface of the reinforcing plate 8 is fixedly connected with the lower surface of the bottom plate 2, the upper surface of the bottom plate 2 is fixedly connected with a standing plate 4, the surface of the standing plate 4 and the electric wheelchair The surface of the support leg 1 is fixedly connected, the surface of the station board 4 is provided with a second adjustment device, and the second adjustment device includes a first bearing 5, the outer ring of the first bearing 5 is fixedly connected to the surface of the station board 4, a plurality of The top of the electric wheelchair support legs 1 are fixedly connected to the seat bottom frame 6, the upper surface of the seat bottom frame 6 is fixedly connected to the armrest 18, the surface of the armrest 18 is fixedly connected to the sheath 19, and the material of the sheath 19 includes water absorption Resin, and water-absorbent resin material processing method: S1, measure 10 mL of acrylic acid in a 100 mL beaker with 20 mL of water, and slowly drop 30% NaOH aqueous solution to pH=6-7, after the neutralizing solution is cooled to room temperature, Add 5.5 g of acrylic amine to the neutralizing solution, then transfer to a 250 mL beaker equipped with a stirrer, S2, weigh 4.4 g of soluble starch, add 20 mL of distilled water, and heat to 90° C. to make it paste, paste After chemical conversion, quickly transfer it to the above 250 mL beaker, then add 0.4 g Triton X-100, S3, dissolve 0.132 g ammonium persulfate in 10 mL water, and slowly drop it into the reaction solution with a thermostatic pressure dropping funnel The reaction was carried out at a constant temperature water bath at 60° C. for 2 hours. Slowly add 0.0128 g of the cross-linking agent N, N′-methylenebisacrylic acid amine dissolved in 10 mL of water, and continue stirring for half an hour. S4. Wash severe 1 times, wash once with ethanol, filter with suction, then After putting it at 105° C. for 25 h, grinding and crushing to obtain powdery water-absorbent resin, the material of the sheath 19 includes water-absorbent resin, so as to achieve the effect of sweating adsorption of the elderly in the wheelchair armrest for a long time. The effect of keeping the hands dry for a long time, due to the recyclable characteristics of the water-absorbing resin, has an environmental effect. The inner wall of the seat bottom frame 6 is hinged with the seat bottom plate 7, and the inner ring of the first bearing 5 is fixedly connected to the gear shaft 51, A large gear 52 is fixedly connected to the surface of the gear shaft 51, a fixed shaft 53 is fixedly connected to one surface of the large gear 52, a l ink 54 is hinged to the surface of the fixed shaft 53, and both ends of the two links 54 are connected to the seat bottom The bottom of 7 is hinged, and the bottom plate 2 is fixedly connected to the surface of the supporting legs 1 of the electric wheelchair. The surface of the bottom plate 2 is provided with a first adjustment device, and, the first adjustment device includes the surface of the motor bottom plate 3 and the standing plate 4 A second adjustment device is provided, and the second adjustment device includes a first bearing 5, which has the characteristics of saving labor costs, avoiding physical injuries of the elderly, and facilitating adjustment of the elderly in a wheelchair. When used, when the elderly need to take a wheelchair At the time, standing next to the wheelchair, holding the sheath 19 on the armrest 18, leaning back on the surface of the seat bottom 7, turning on the, motor 31 to rotate the rotating shaft 32 to rotate the turbine 33, and driving the worm 13 Rotate, which drives the pinion 12 to rotate, rotates the large gear 52, and drives the connecting rod 54 to move downward so that the elderly can slowly sit down. When the seat bottom plate 7 contacts the upper limit switch 17, it stops. When the control motor 31 rotates to drive the contact 14 to contact the lower limit switch 16 to stop the seat bottom plate 7 at an oblique angle to prepare the elderly to take a wheelchair, thereby saving labor costs, avoiding physical injuries to the elderly, and facilitating adjustment of the elderly to take a wheelchair specialty.

### Example Three

A mobility tool for the elderly to go out, as shown in FIG. 1-6, includes an electric wheelchair support leg 1, a plurality of electric wheelchair support legs 1 are fixedly connected to the bottom plate 2 on the surface, and a bearing is fixedly connected to the upper surface of the bottom plate 2 Seat 9, the surface of the bearing housing 9 is fixedly connected with the second bearing 10, the inner ring of the second bearing 10 is fixedly connected with the pinion shaft 11, one end of the pinion shaft 11 is fixedly connected with the pinion 12, the surface of the pinion 12 and The surface of the large gear 52 is meshed, the other ends of the two small gear shafts 11 are fixedly connected to the worm 13, the surface of the motor base plate 3 is fixedly connected to the motor 31, and the output shaft of the motor 31 is fixedly connected to the rotating shaft 32 through the coupling. A turbine 33 is fixedly connected to one end of the rotating shaft 32, the surface of the rotating shaft 32 is in fixed communication with the surface of the bottom plate 2, the surface of the turbine 33 meshes with the surface of the worm 13, and the contact 14 is fixedly connected to the other surface of the large gear 52, The upper surface of the bottom plate 2 is fixedly connected with the limit block 15, the top of the limit block 15 is fixedly connected with the lower limit switch 16, the surface of the contact 14 is in contact with the contact point of the lower limit switch 16, and the upper surface of the station board 4 is fixedly connected with The upper limit switch 17, the upper limit switch 17 and the lower limit switch 16 are model YBLXW-5-11G2, and the motor 31 is model 60HS10014A4. The surface of the bottom plate 2 is provided with a first adjustment device, and the first adjustment device includes a motor bottom plate 3. The surface of the motor bottom plate 3 is fixedly connected with a reinforcing plate 8, the surface of the reinforcing plate 8 is fixedly connected with the lower surface of the bottom plate 2, the upper surface of the bottom plate 2 is fixedly connected with a standing plate 4, and the surface of the standing plate 4 is connected with the support leg of the electric wheelchair The surface of 1 is fixedly connected, the surface of the station board 4 is provided with a second adjustment device, and the second adjustment device includes a first bearing 5, the outer ring of the first bearing 5 is fixedly connected to the surface of the station board 4, a plurality of electric wheelchairs The top of the support legs 1 are fixedly connected to the seat bottom frame 6, the upper surface of the seat bottom frame 6 is fixedly connected to the armrest 18, the surface of the armrest 18 is fixedly connected to the sheath 19, and the material of the sheath 19 includes water-absorbent resin, And the processing method of water-absorbent resin material: S1, measure 10 mL of acrylic acid in a 100 mL beaker with 20 mL of water, and slowly add a 30% strength NaOH aqueous solution to pH=6-7. After the neutralizing solution is cooled to room temperature, add 5.5 g of acrylic amine is added to the neutralization solution, and then transferred to a 250 mL beaker equipped with a stirrer. S2, weigh 4.4 g of soluble starch, add 20 mL of distilled water, and heat to 100° C. to make it gelatinize. Quickly transfer it to the above 250 mL beaker, then add 0.4 g Triton X-100, 53, dissolve 0.132 g of ammonium persulfate in 10 mL water, slowly drop it into the reaction solution with a thermostatic pressure dropping funnel, constant temperature water bath After reacting at 60° C. for hours, slowly add 0.0128 g of cross-linking agent N, N′ -methylenebisacrylic acid amine dissolved in 10 mL of water, and continue to stir for half an hour. S4. Wash the gum obtained by the reaction with water Times, after washing with ethanol once, filtering with suction, then put After drying at 105° C. for 25 h, grinding and crushing can obtain powdery water-absorbent resin. The material of the sheath 19 includes water-absorbent resin, so as to achieve the effect of sweat absorption of the elderly in the wheelchair armrest for a long time, and keep the hand for a long time. The drying effect of the parts is environmentally friendly due to the recyclable characteristics of the water-absorbing resin. The inner wall of the seat bottom frame 6 is hinged with the seat bottom plate 7, the inner ring of the first bearing 5 is fixedly connected to the gear shaft 51, the gear shaft A large gear 52 is fixedly connected to the surface of 51, and a fixed shaft 53 is fixedly connected to one surface of the large gear 52. A link 54 is hinged to the surface of the fixed shaft 53, and both ends of the two links 54 are connected to the bottom of the seat bottom 7 Hinged, the bottom plate 2 is fixedly connected to the surface of the supporting legs 1 of the electric wheelchair. The surface of the bottom plate 2 is provided with a first adjustment device, and the first adjustment device includes a motor bottom plate 3, and the surface of the stand plate 4 is provided with a first Two adjustment devices, and the second adjustment device includes the first bearing 5, which has the characteristics of saving labor costs, avoiding physical injuries of the elderly, and facilitating the adjustment of the elderly in a wheelchair. When used, when the elderly need to take a wheelchair, stand Hold the sheath 19 on the armrest 18 next to the wheelchair, and lean back on the surface of the seat floor 7, turn on the motor 31 and rotate the rotating shaft 32 to rotate the turbine 33, and the worm 13 to rotate through the engagement, so Drive the pinion gear 12 to rotate, drive the large gear 52 to rotate, and drive the connecting rod 54 to move downward so that the elderly can slowly sit down. When the seat bottom plate 7 contacts the upper limit switch 17, it stops, and the motor is controlled when it is not needed. 31 Rotating the driving contact 14 to contact the lower limit switch 16 causes the seat bottom plate 7 to stop at an oblique angle to prepare the elderly to take a wheelchair, thereby saving labor costs, avoiding physical injuries to the elderly, and facilitating adjustment of the wheelchair for the elderly.

This specific embodiment is merely an explanation of the present invention, and it is not a limitation of the present invention. Those skilled in the art can make modifications without creative contribution to this embodiment after reading this specification, but as long as they Within the scope of the requirements are protected by patent law.

1. A mobility tool for the elderly to go out, including an electric wheelchair support leg (1), characterized in that: a plurality of electric wheelchair support legs (1) are all fixedly connected with a bottom plate (2) on the surface (2) The surface is provided with a first adjusting device, and the first adjusting device includes a motor bottom plate (3), a top plate (4) is fixedly connected to the upper surface of the bottom plate (2), and the top plate (4) The surface of the electric wheelchair is fixedly connected with the surface of the support leg (1) of the electric wheelchair, the surface of the station board (4) is provided with a second adjustment device, and the second adjustment device includes a first bearing (5), the first bearing (5) The outer ring is fixedly connected to the surface of the standing board (4), and the seat bottom frame (6) is fixedly connected to the tops of the plurality of electric wheelchair support legs (1), and the seat bottom frame (6)) The inner wall is hinged with a seat bottom plate (7).

2. A mobility tool for the elderly to go out according to claim 1, characterized in that: the surface of the motor bottom plate (3) is fixedly connected with a reinforcing plate (8), It is fixedly connected to the lower surface of the bottom plate (2).

3. The mobility tool for the elderly to go out according to claim 1, characterized in that: the inner ring of the first bearing (5) is fixedly connected with a gear shaft (51), the surface of the gear shaft (51) A large gear (52) is fixedly connected, a surface of the large gear (52) is fixedly connected with a fixed shaft (53), a surface of the fixed shaft (53) is hinged with a connecting rod (54), and two One end of the connecting rod (54) is hinged with the bottom of the seat bottom plate (7).

4. The mobility tool for the elderly to go out according to claim 3, characterized in that: a bearing seat (9) is fixedly connected to the upper surface of the bottom plate (2), and the surface of the bearing seat (9) is fixedly connected There is a second bearing (10), an inner ring of the second bearing (10) is fixedly connected with a pinion shaft (11), and one end of the pinion shaft (11) is fixedly connected with a pinion gear (12), The surface of the pinion gear (12) meshes with the surface of the large gear (52), and the other ends of the two pinion shafts (11) are fixedly connected with a worm (13).

5. The mobility tool for the elderly to go out according to claim 4, characterized in that: a motor (31) is fixedly connected to the surface of the motor bottom plate (3), and the output shaft of the motor (31) passes through the coupling shaft A rotary shaft (32) is fixedly connected to the rotor, and a turbine (33) is fixedly connected to one end of the rotary shaft (32). The surface of 33) meshes with the surface of the worm (13).

6. The mobility tool for the elderly to go out according to claim 3, characterized in that: the other side surface of the large gear (52) is fixedly connected with a contact (14), and the bottom plate (2) The surface is fixedly connected with a limit block (15), a top of the limit block (15) is fixedly connected with a lower limit switch (16), and the surface of the contact (14) is in contact with a contact point of the lower limit switch (16) The upper surface of the station board (4) is fixedly connected with an upper limit switch (17).

7. The mobility tool for the elderly to go out according to claim 6, characterized in that: the model of the upper limit switch (17) and the lower limit switch (16) s YBLXW-5-11G2, the motor (31) Model is 60HS10014A4.

8. The mobility tool for the elderly to go out according to claim 1, characterized in that: the upper surface of the seat bottom frame (6) is fixedly connected with an armrest (18), and the surface of the armrest (18) is fixed A sheath (19) is connected.

9. The mobility tool for the elderly to go out according to claim 8, characterized in that: the material of the sheath (19) includes a water-absorbent resin, and the processing method of the water-absorbent resin material: S1, measure 10 mL acrylic acid to In a 100 mL beaker of 20 mL water, slowly add a 30% strength NaOH aqueous solution to pH=6-7. After the neutralizing solution is cooled to room temperature, add 5.5 g acrylamide to the neutralization solution, and then transfer to In a 250 mL beaker with a stirrer, S2, weigh 4.4 g of soluble starch, add 20 mL of distilled water, and heat to 80° C.-100° C. to gelatinize, after gelatinization, quickly transfer it to the above 250 mL beaker, then Add 0.4 g Triton X-100.

10. The method for producing a water-absorbent resin according to claim 9, comprising: S3, dissolving 0.132 g of ammonium per sulfate in 10 mL of water, slowly dropping it into the reaction solution with a thermostatic pressure dropping funnel, and a thermostatic water bath 60 React for 2 hours at ° C., slowly add 0.0128 g of cross-linking agent N, N′-methylenebisacrylamide acid amine dissolved n 10 mL of water, continue stirring for half an hour, S4, wash the gum obtained by the reaction several times with water After washing with ethanol once, filtering with suction, and then putting it to dry at 105° C. for 25 h, grinding and crushing to obtain powdery water-absorbing resin.
